(19) United States
(12) Patent Application Publication
(10) Pub. No.: US 2015/0289224 A1
(43) Pub. Date: Oct. 8, 2015

(54) METHOD AND SYSTEM TO IMPROVE REGISTRATION FOR VoLTE DEVICES IN LTE NETWORKS

(71) Applicant: Samsung Electronics Co., Ltd., Gyeonggi-do (KR)

(72) Inventors: Ajay kumar KABADI, Gyeonggi-do (KR); Kedar Santosh Kumar AALLA, Bangalore (IN); Durga Prasad KATTAMANCHI, Bangalore (IN); Smivas CHINTHALAPUDI, Bangalore (IN); Jai-Dong KIM, Gyeonggi-do (KR); Hyeun Mok JUNG, Gyeonggi-do (KR)

(21) Appl. No.: 14/678,236

(22) Filed: Apr. 3, 2015

Related U.S. Application Data
(60) Provisional application No. 61/974,754, filed on Apr. 3, 2014.

(30) Foreign Application Priority Data
Feb. 11, 2015 (KR) 10-2015-0021028

(51) Int. Cl. H04W 60/04; H04W 48/04; H04L 29/06

(52) U.S. Cl. CPC H04W 60/04; H04L 65/1016; H04L 65/1073; H04W 48/04

(57) ABSTRACT

Methods for improving registration for VoLTE devices in LTE networks are provided. One method for improving registration for VoLTE devices in LTE networks includes the steps of transmitting, by a user equipment (UE), a first Packet Data Network (PDN) connectivity request to a first PDN Gateway (PGW) for establishing a connectivity with a first PDN; verifying, by a Mobility Management Entity (MME), if the first PDN connectivity request is accepted by the first PGW; creating, by the UE, a second PDN connectivity request to a second PGW for establishing a connectivity with a second PDN if the first PGW rejects the first PDN connectivity request; and establishing connectivity with the second PDN for enabling VoLTE Services if the second PGW accepts the second PDN connectivity request.

### PRIORITY

This application claims priority under 35 U.S.C. §119(e) to U.S. Prov. App. Ser. No. 61/974,754, filed on Apr. 3, 2014, and under 35 U.S.C. §119(a) to the Korean Patent Application which was filed on Feb. 11, 2015 in the Korean Intellectual Property Office and assigned serial No. 10-2015-0021028, the contents of each of which are incorporated herein by reference.

### BACKGROUND

1. Field of the Disclosure

The present disclosure relates generally to Long Term Evolution (LTE) mobile communication technology and, more particularly, to the handling of voice call services on an LTE network, including the enabling of enhanced Voice over LTE (VoLTE) registration for the user.

2. Description of the Related Art

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include Code Division Multiple Access (CDMA) systems, Time Division Multiple Access (TDMA) systems, Frequency Division Multiple Access (FDMA) systems, Orthogonal Frequency Division Multiple Access (OFDMA) systems, Single-Carrier Frequency Division Multiple Access (SC-FDMA) systems, and Time Division Synchronous Code Division Multiple Access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE).

LTE is a mobile network standard for the wireless communication of high-speed data. The standard has been developed by the 3GPP (3rd Generation Partnership Project) and is specified in its Release 8 and 9 document series. In contrast to the circuit-switched (CS) model of earlier cellular network standards, LTE has been designed to support only packet-switched (PS) services. Voice over LTE (VoLTE) is a mobile network standard to support voice calls over the LTE network. VoLTE delivers voice service as data flows within the LTE data bearer, and therefore avoids dependency on the present 2G or 3G CS cellular networks. However, while VoLTE technology is being introduced, and for a long time thereafter, there will be the need to support voice calls between VoLTE mobile devices and legacy CS network mobile devices.

Subsequently, due to a lack of coordination between EMM and ESM, EMM may trigger RAT selection to a LEGACY network even though ESM wants a PDN connection to get services (VoLTE/INTERNET) on LTE. Due to this, UE may not get LTE service for other required PDN. Further there may be a delay in the registration in LTE.

For example, consider a case of VoLTE device registration, where T-Mobile US-VoLTE Registration for VoLTE Services is initiated. UE is trying to Attach for LTE with Internet as Default PDN and IMS as second Default PDN. Due to heavy load or some temporary issue at INTERNET Server, UE is not able to attach. In this case, UE cannot connect to IMS Server to get VoLTE and IMS Services services.

In another case, UE is trying to Attach for LTE with IMS as Default PDN and INTERNET as second Default PDN. Due to heavy load or some temporary issue at IMS Server, UE not able to attach. In this case, UE cannot connect to Internet Server to get Internet services.

In view of the foregoing, there is a need to provide a method which provides better LTE experience to the users during registration of VoLTE services.

The above mentioned shortcomings, disadvantages and problems are addressed herein and which will be understood by reading and studying the following specification.

### SUMMARY

The various embodiments herein provide a method for improving registration for VoLTE devices in LTE networks.

According to one embodiment, a method is provided for improving registration for Voice over Long Term Evolution (VoLTE) devices in LTE networks, the method including: transmitting, by a user equipment (UE), a first Packet Data Network (PDN) connectivity request to a first PDN Gateway (PGW) for establishing a connectivity with a first PDN; verifying, by a Mobility Management Entity (MME), if the first PDN connectivity request is accepted by the first PGW; creating, by the UE, a second PDN connectivity request to a second PGW for establishing a connectivity with a second PDN if the first PGW rejects the first PDN connectivity request; and establishing connectivity with the second PDN for enabling VoLTE Services if the second PGW accepts the second PDN connectivity request.

According to another embodiment, a method is provided for improving registration for Voice over Long Term Evolution (VoLTE) devices in LTE networks, the method including: creating, by a User Equipment (UE), a first Packet Data Network (PDN) connectivity request for establishing connectivity with a first PDN for establishing a call; encapsulating, by the UE, an Evolved Packet Service (EPS) Session Management (ESM) message container in the first PDN connectivity request for sending a second PDN connectivity request in parallel with the first PDN connectivity request; transmitting, by the UE, the first PDN connectivity request to a Mobile Management Entity (MME); triggering, by the MME, the first connectivity request to a first PDN gateway (PGW) of the first PDN and the second connectivity request to a second PGW of the second PDN in parallel; and establishing, by the UE, a PDN connectivity with at least one of the first PDN and the second PDN.

According to another embodiment, a system is provided including: a User Equipment (UE) for wireless communication with a Mobile Management Entity (MME) adapted for improving registration for Voice over Long Term Evolution (VoLTE) enabled services in LTE networks, wherein the UE is configured for: transmitting a first Packet Data Network (PDN) connectivity request to a first PDN Gateway (PGW) for establishing a connectivity with a first Packet Data Network (PDN); creating, by the UE, a second PDN connectivity request if the first PGW rejects the first PDN connectivity request; and establishing a second PDN connectivity with a second PDN for providing VoLTE enabled Services.

According to yet another embodiment, a system is provided including: a User Equipment (UE) for wireless communication with a Mobile Management Entity (MME) adapted for improving registration for Voice over Long Term Evolution (VoLTE) enabled services in LTE networks, wherein the UE is configured for: creating a first Packet Data Network (PDN) connectivity request for establishing connectivity with a first Packet Data Network (PDN) for establishing a call; encapsulating an Evolved Packet Service (EPS) Session Management (ESM) message container in the first PDN connectivity request for sending a second PDN connectivity request in parallel with the first PDN connectivity request; transmitting the first PDN connectivity request to a Mobile Management Entity (MME); and establishing a PDN connectivity with at least one of the first PDN and the second PDN in response to parallel triggering of the first connectivity request to the first PDN and the second connectivity request to the second PDN by the MME.

According to still another embodiment, a system is providing, including: a User Equipment (UE) for wireless communication with a Mobile Management Entity (MME) adapted for improving registration for Voice over Long Term Evolution (VoLTE) enabled services in LTE networks, wherein the UE is configured for: creating a first Packet Data Network (PDN) connectivity request for establishing connectivity with a first Packet Data Network (PDN) for establishing a call; encapsulating an Evolved Packet Service (EPS) Session Management (ESM) message container in the first PDN connectivity request for sending a second PDN connectivity request in parallel with the first PDN connectivity request; transmitting the first PDN connectivity request to a Mobile Management Entity (MME); and establishing a PDN connectivity with at least one of the first PDN and the second PDN in response to parallel triggering of the first connectivity request to the first PDN and the second connectivity request to the second PDN by the MME.

### BRIEF DESCRIPTION OF THE DRAWINGS

The above and other aspects, features and advantages will occur to those skilled in the art from the following description of various embodiments and the accompanying drawings in which:

FIG. 1 is a block diagram of a LTE system illustrating a conventional signal flow for VoLTE registration;

FIG. 2 is a conventional signal flow diagram for VoLTE registration with INTERNET as Default PDN and IMS as second Default PDN;

FIG. 3 is a process flow diagram for providing a second default PDN connectivity in a second attach during VoLTE registration, according to an embodiment herein;

FIG. 4 is a process flow diagram for providing parallel PDN connectivity during attach with two PDNS during VoLTE registration, according to an embodiment herein;

FIG. 5 is a flow chart illustrating a method of providing a second default PDN connectivity in a second attach during VoLTE registration, according to an embodiment herein; and

FIG. 6 is a flow diagram for providing parallel PDN connectivity during attach with two PDNS during VoLTE registration, according to an embodiment herein.

Specific features of the present disclosure may be shown in some drawings and not in others. This is done for convenience only as each feature may be combined with any or all of the other features in accordance with the present disclosure.

### DETAILED DESCRIPTION OF THE EMBODIMENTS

The present disclosure provides a method and system for managing variance data and disputes associated with account payables of an organization. In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following detailed description is, therefore, not to be taken in a limiting sense, and the scope of the present disclosure is defined only by the appended claims.

It should be understood that the following descriptions, while indicating embodiments and numerous specific details thereof, are given by way of illustration and not of limitation. Many changes and modifications may be made within the scope of the embodiments herein without departing from the spirit thereof, and the embodiments herein include all such modifications.

The present disclosure provides a method and system for managing variance data and disputes associated with account payables of an organization. In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following detailed description is, therefore, not to be taken in a limiting sense, and the scope of the present disclosure is defined only by the appended claims.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

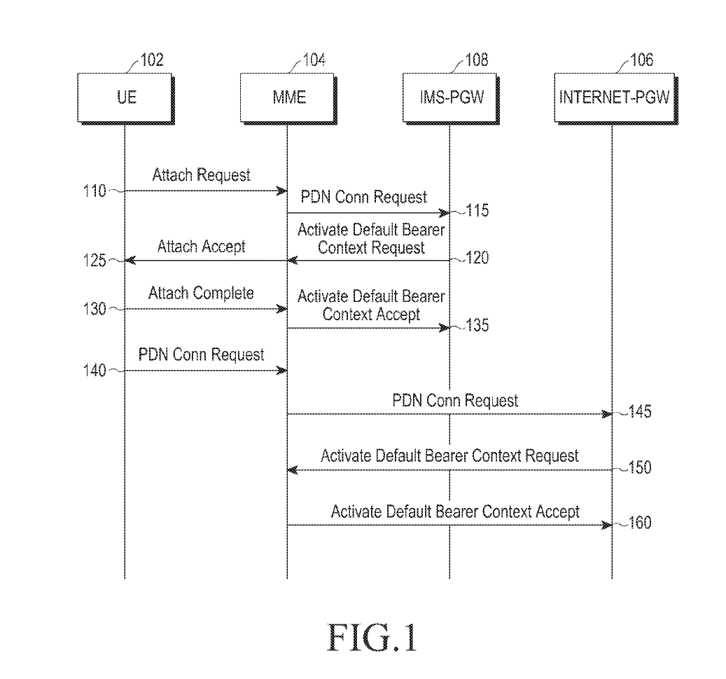

FIG. 1 is a block diagram of a LTE system illustrating a conventional signal flow for VoLTE registration, to which embodiments of the disclosure may be applied. The User Equipment (UE) 102 sends an attach request 110 for data services to the Mobile Management Entity (MME) 104. The MME 104 transmits a PDN Connectivity Request (PDN Conn Request 115) which carries the information on to the IMS-PGW 108. The IMS-PGW 108 transmits an ACTIVATE DEFAULT BEARER CONTEXT REQUEST 120 to the MME 104 and then the MME 104 transmits an ATTACH ACCEPT message 125 to the UE 102. Once the UE 102 is registered with the IMS PDN, the UE 102 sends an ATTACH COMPLETE message 130 to the MME 104. The UE 102 confirms successful completion with an RRC Connection Reconfiguration Complete message and then finalizes the ATTACH procedure and accepts the activation of the EPS bearer.

The MME 104 then transmits an ACTIVATE DEFAULT BEARER CONTEXT ACCEPT message 135 to the IMS PGW 108. Then UE 102 then transmits a PDN connectivity request (PDN Conn Request 140) to MME 104, which transmits it 145 the Internet PGW 106. The Internet PGW 106 then transmits and ACTIVATE DEFAULT BEARER CONTEXT REQUEST 150 to the MME 104. The MME 104 then activates and sends an ACTIVATE DEFAULT BEARER CONTEXT ACCEPT 160 to the Internet PGW 106.

It should be noted that the way a default PDN is associated with an IMS device varies per the network operator. In some networks, powering on a device will cause it to attempt to establish a connection with an Internet PDN. In this case the device will only establish IMS connectivity when an IMS application needs to be serviced. A device used on another network will, on powering up, attempt to establish a connection with an IMS PDN, and display a “No Service” message if the connection is not made.

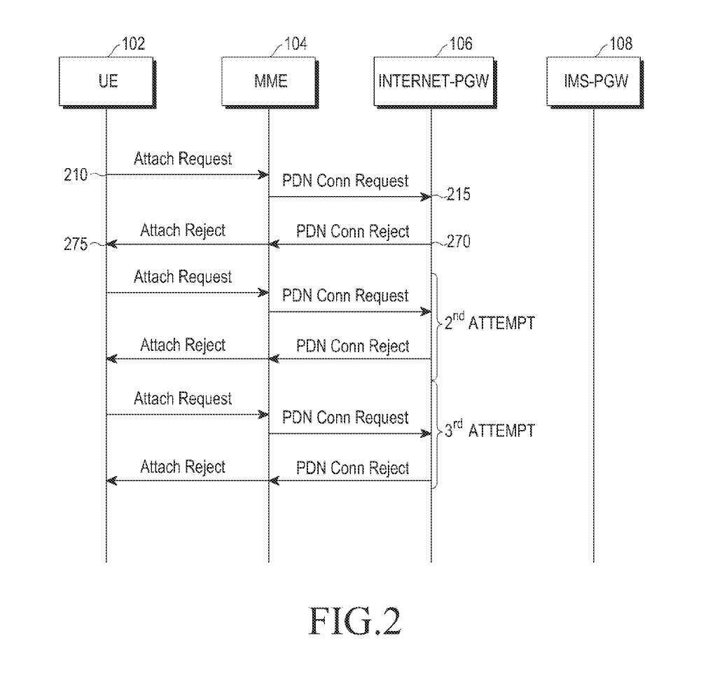

FIG. 2 is a conventional signal flow diagram for VoLTE registration with INTERNET as Default PDN and IMS as second Default PDN.

In FIG. 2, the UE 102 is trying to attach for LTE services with Internet as the default PDN and IMS as second default PDN. The UE 102 sends an ATTACH REQUEST 210 to the MME. The ATTACH REQUEST 210 inside of PDN CONN REQUEST 215 is transmitted to the INTERNET PGW 106 by the MME 104. However, due to heavy load or some temporary issue at the INTERNET server, the INTERNET PGW 106 rejects the connection request with PDN CONN REJECT 270, which MME 104 forwards to UE 102 in an ATTACH REJECT 275, and hence the UE is not able to attach. After trying two more times, the UE cannot connect to IMS server to get VoLTE services.

In another scenario, where the UE is trying to attach for LTE services with IMS as the default PDN and Internet as second default PDN. Due to heavy load or some other temporary issue at IMS PGW, the UE is not able to attach with the IMS PGW. In this case, the UE cannot connect to Internet Server to get Internet services.

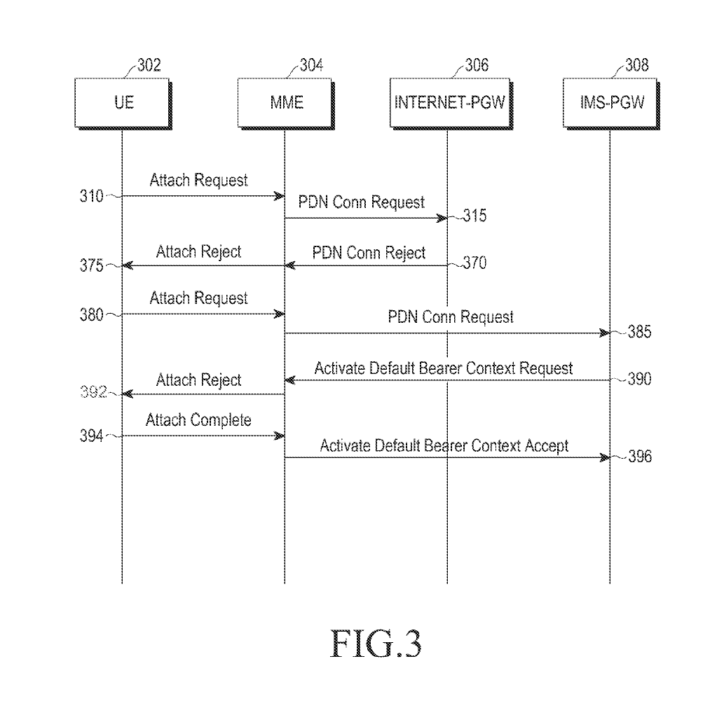

FIG. 3 is a process flow diagram for providing a second default PDN connectivity in a second attach procedure during VoLTE registration, according to one embodiment. According to an embodiment of the present disclosure, the access point needs to inform the network about the default PDNs that are going to be established during the registration. The EPS Session Management (ESM) protocol has to maintain a number of default PDNs available for registration and its priority of service for LTE. Further, the EPS Mobility Management (EMM) should wait for an ESM indication before taking Radio Access Technology (RAT) change decisions during temporary or permanent ESM failure. According to an embodiment herein, at least one of the following actions is required in ESM to update EMM for RAT coordination.
1. If IMS PDN is primary and is rejected with permanent or temporary ESM cause, then try Internet PDN on LTE, and if that is also rejected, then go to the legacy network for CS services.
2. If Internet PDN is primary and is rejected with permanent ESM cause, then select the legacy network for CS services, if the legacy network is supported.
3. If Internet PDN is primary and is rejected with temporary ESM cause, then connectivity can be established with the IMS PDN for VoLTE services on the LTE network.

As shown in FIG. 3, the UE 302 sends an ATTACH REQUEST 310 having a PDN connection request (PDN CONN REQUEST 315) which is forwarded to the Internet PGW 306 through the MME 304. The Internet PGW 306 rejects the PDN connectivity request with PDN CONN REJECT 370 to MME 304 which sends UE 302 an ATTACH REJECT message 375.

Then UE 302 generates a second ATTACH REQUEST 380 to establish PDN connectivity with the IMS server 308, which is forwarded by MME 304 through a second default PDN connectivity request (PDN CONN REQUEST 385) to IMS PGW 308. The IMS PGW 308 then sends an ACTIVATE DEFAULT BEARER CONTEXT REQUEST 390 to the MME 304 and the MME 304 sends an ATTACH ACCEPT message 392 to the UE 302. The UE 302 then sends an ATTACH COMPLETE message 394 to the MME 304. The MME 304 then sends ACTIVATE DEFAULT BEARER CONTEXT ACCEPT message 396 to the IMS server 308, thereby establishing UE 302 connectivity with the second default PDN for VoLTE services.

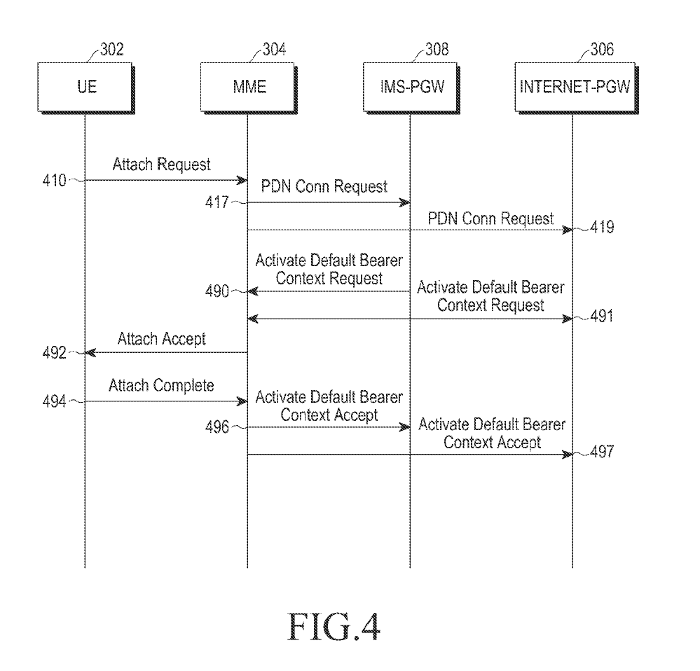

FIG. 4 is a process flow diagram for providing parallel PDN connectivity by attaching with two PDNS during VoLTE registration, according to one embodiment. Establishing parallel PDN connectivity avoids registration failure. Here new Information Elements (IEs) are introduced in the attach procedure during which a second default PDN connectivity request is carried as an optional element to get LTE service during initial registration itself.

The UE 302 sends an ATTACH REQUEST 410 to the MME 304. The ATTACH REQUEST 410 includes additional information elements (IEs), such as the number of Access Point Names (APNs) and an extra ESM message container. The UE 302 encapsulates the extra ESM message container with the number of APNs IE in the ATTACH REQUEST message when UE 302 wants more than one default PDN Connection. The MME 304 on receiving the ATTACH REQUEST message from the UE 302, triggers, in parallel, a PDN connectivity request (PDN CONN REQUEST 417) to the IMS PGW 308 and a PDN connectivity request (PDN CONN REQUEST 419) to INTERNET PGW 306. The IMS PGW 308 and the Internet PGW 306 accept the requests and send ACTIVATE DEFAULT BEARER CONTEXT REQUEST messages 490 and 491, respectively, to MME 304, which results in ATTACH ACCEPT message 492 being sent to the UE 302. The ATTACH ACCEPT message encapsulates another ESM message container with the number of APNs which UE 302 wants to set up via more than one default PDN connection. The UE 302 transmits an ATTACH COMPLETE message 494 to MME 304 in order to inform both the default PDNs. The UE 302 encapsulates another ESM message container in the ATTACH COMPLETE message and the number of APNs IE when UE 302 wants to send more than one default PDN Connections. Upon receipt, MME 304 transmits ACTIVATE DEFAULT BEARER CONTEXT ACCEPT messages 496 and 497 to IMS PGW 308 and Internet PGW 306, respectively. Based on the PDN connectivity responses from the PDN PGWs, MME makes the decision whether to send ATTACH ACCEPT 492 (or ATTACH REJECT).

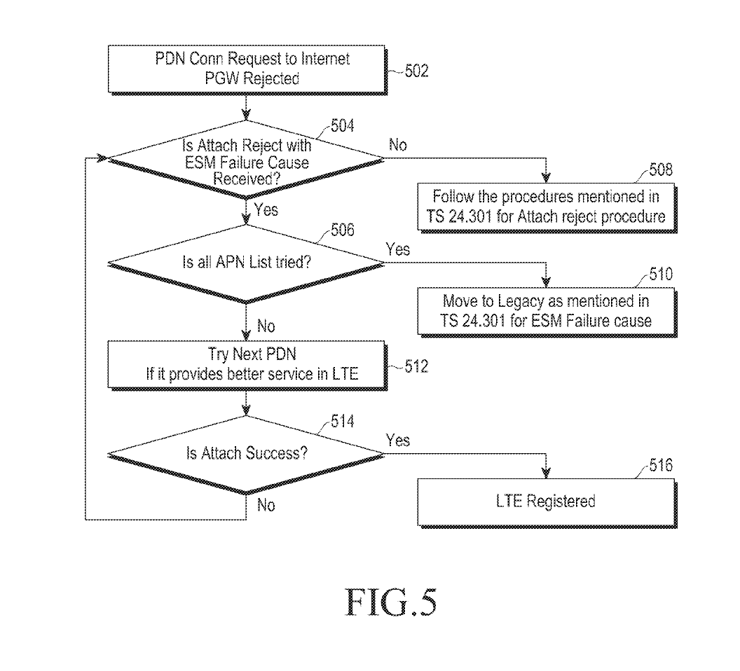

FIG. 5 is a flow chart illustrating a method of providing a second default PDN connectivity using a second attach procedure during VoLTE registration, according to an embodiment herein.

At step 502 of FIG. 5, the UE initiates an ATTACH request to the Mobile Management Entity (MME). The ATTACH request includes a PDN connection request, which is transmitted to the INTERNET PGW by the MME. In step 504, it is determined whether the UE receives an ATTACH REJECT message with an ESM failure cause or not. If the ATTACH REJECT message does not contain an ESM failure cause, then at step 508, follow the Attach Reject procedures in the 3GPP Technical Specification (TS) 24.301, which is hereby incorporated by reference in its entirety.

If the ATTACH REJECT message does not contain an ESM failure cause in step 504, then it is determined whether all the entries in the APN list corresponding to the PDN identities have been checked or not in step 506. If all the entries in the APN list have not been tried in step 506, the UE moves to a legacy network as described in 3GPP TS 24.301 for ESM Failure cause, at step 510.

According to one embodiment herein, the Access Point Name (APN) is the name of a gateway between a GPRS, 3G or 4G mobile network and another computer network, such as the public Internet. The APN identifies the Packet Data Network (PDN) that a mobile data user wants to communicate with. In addition to identifying a PDN, an APN may also be used to define the type of service, e.g., connection to Wireless Application Protocol (WAP) server, Multimedia Messaging Service (MMS), etc., that is provided by the PDN. APN is used in 3GPP data access networks, e.g., General Packet Radio Service (GPRS), evolved packet core (EPC), etc. The APN list includes, but is not limited to:
Airtel APN—airtelgprs.com
Vodafone APN—www
Idea APN—internet, imis
Aircel APN—aircelwap, aircelgprs
Uninor APN—Uninor (U Must be written in Capital Letter)
Videocon APN—vinternet.com
BSNL APN—bsnlnet
TATA Docomo APN—TATA.DOCOMO.INTERNET
Reliance APN—rcomnet, smarinet, rcomwap
Virgin Mobile APN—vinternet
Loop Mobile APN—www

If all of the entries in the APN list have not been tried in step 506, the next PDN is tried by generating a second ATTACH REQUEST to establish PDN connectivity with the IMS server at step 512. In step 514, it is determined whether the second ATTACH Request message is accepted. If the second ATTACH Request message is accepted, the LTE connection is registered at step 516. If the second ATTACH Request message is not accepted, the method loops back to step 504.

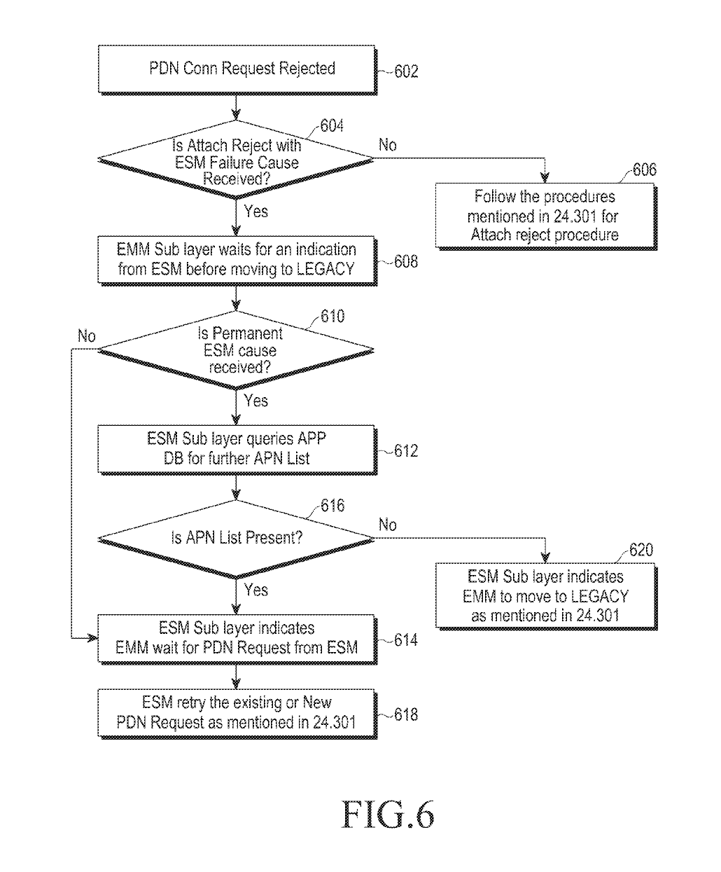

FIG. 6 is a flow diagram illustrating a method of providing parallel PDN connectivity by attaching with two PDNS during VoLTE registration, according to an embodiment herein. At step 602, like step 502 in FIG. 5, a PDN connectivity request from the UE has been rejected. At step 604, like step 504, it is determined whether the received ATTACH REJECT has an ESM failure cause or not. If the ATTACH REJECT message is received with no ESM failure cause, then ATTACH REJECT procedures as mentioned in TS 24.301 are followed at step 606.

If an attach reject message with an ESM failure cause is received, then at step 608 the Mobility Management Sublayer (EMM) sub layer waits for an indication from ESM before moving to a legacy network.

The main function of the ESM sublayer is to support the EPS bearer context handling in the UE and in the MME. The ESM has procedures for the activation, deactivation and modification of EPS bearer contexts and the request for resources (IP connectivity to a PDN or dedicated bearer resources) by the UE. Each EPS bearer context represents an EPS bearer between the UE and a PDN. EPS bearer contexts can remain activated even if the radio and S1 bearers constituting the corresponding EPS bearers between UE and MME are temporarily released. An EPS bearer context can be either a default bearer context or a dedicated bearer context. A default EPS bearer context is activated when the UE requests a connection to a PDN.

The main function of the EMM sublayer is to support the mobility of a user equipment, such as informing the network of its present location and providing user identity confidentiality. A further function of the EMM sublayer is to provide connection management services to the session management (SM) sublayer and the short message services (SMS) entity of the connection management (CM) sublayer. All of the EMM procedures described in this paragraph can only be performed if a NAS signaling connection has been established between the UE and the network. Otherwise, the EMM sublayer has to initiate the establishment of a NAS signaling connection.

At step 610 of FIG. 6, it is determined whether the received ESM cause is a permanent ESM cause or not. If a permanent ESM cause was received, then at step 612, the ESM sublayer queries an Application Database (APP DB) for further APN list. At step 616, it is determined whether an additional APN list is present or not. If an additional APN list is present in step 616 or if no permanent ESM cause was received in step 610, then at step 614, the ESM sublayer indicates EMM wait for PDN request from ESM. Then, at step 618, ESM retires the existing or new PDN request as per the standards. If no APN list is present in step 616, then the ESM sublayer indicates EMM to move to legacy network at step 620.

FIGS. 1 through 6 discussed above, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication device. Since the present disclosure may have diverse modified embodiments, certain embodiments are illustrated in the drawings and are described in the detailed description of the disclosure. However, this does not limit the present disclosure within specific embodiments and it should be understood that the present disclosure covers all the modifications, equivalents, and replacements within the idea and technical scope of the present disclosure.

The present embodiments have been described with reference to specific example embodiments; it will be evident that various modifications and changes may be made to these embodiments without departing from the broader spirit and scope of the various embodiments. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

Although the embodiments herein are described with various specific embodiments, it will be obvious for a person skilled in the art to practice the disclosure with modifications. However, all such modifications are deemed to be within the scope of the claims. It is also to be understood that the following claims are intended to cover all of the generic and specific features of the embodiments described herein and all the statements of the scope of the embodiments which as a matter of language might be said to fall there between.

What is claimed is:

1. A method for improving registration for Voice over Long Term Evolution (VoLTE) devices in LTE networks, the method comprising:
transmitting, by a user equipment (UE), a first Packet Data Network (PDN) connectivity request to a first PDN Gateway (PGW) for establishing a connectivity with a first PDN;
verifying, by a Mobility Management Entity (MME), if the first PDN connectivity request is accepted by the first PGW;
creating, by the UE, a second PDN connectivity request to a second PGW for establishing a connectivity with a second PDN if the first PGW rejects the first PDN connectivity request; and
establishing connectivity with the second PDN for enabling VoLTE Services if the second PGW accepts the second PDN connectivity request.

2. The method of claim 1, wherein the first PDN is one of an IP Multimedia Subsystem (IMS) PDN or an INTERNET PDN.

3. The method of claim 1, wherein the second PDN is one of an IP Multimedia Subsystem (IMS) PDN or an INTERNET PDN.

4. The method of claim 1, further comprising:
switching, by the UE, to a legacy network for establishing a call, if both the first PDN connectivity request and the second PDN connectivity request are rejected.

5. A method for improving registration for Voice over Long Term Evolution (VoLTE) devices in LTE networks, the method comprising:
creating, by a User Equipment (UE), a first Packet Data Network (PDN) connectivity request for establishing connectivity with a first PDN for establishing a call;
encapsulating, by the UE, an Evolved Packet Service (EPS) Session Management (ESM) message container in the first PDN connectivity request for sending a second PDN connectivity request in parallel with the first PDN connectivity request;
transmitting, by the UE, the first PDN connectivity request to a Mobile Management Entity (MME);
triggering, by the MME, the first connectivity request to a first PDN gateway (PGW) of the first PDN and the second connectivity request to a second PGW of the second PDN in parallel; and
establishing, by the UE, a PDN connectivity with at least one of the first PDN and the second PDN.

6. The method of claim 5, wherein the UE establishes PDN connectivity with at least one of the first PDN and the second PDN based on network conditions.

7. The method of claim 5, wherein the ESM message container includes an Information Element (IE) providing a number of Access Point Names (APNs).

8. The method of claim 5, further comprising:
switching, by the UE, to a legacy network for establishing a call, if both the first PDN connectivity request and the second PDN connectivity request are rejected.

9. A system comprising:
a User Equipment (UE) for wireless communication with a Mobile Management Entity (MME) adapted for improving registration for Voice over Long Term Evolution (VoLTE) enabled services in LTE networks, wherein the UE is configured for:
transmitting a first Packet Data Network (PDN) connectivity request to a first PDN Gateway (PGW) for establishing a connectivity with a first Packet Data Network (PDN);
creating, by the UE, a second PDN connectivity request if the first PGW rejects the first PDN connectivity request; and
establishing a second PDN connectivity with a second PDN for providing VoLTE enabled Services.

10. The system of claim 9, wherein the first PDN is one of an IP Multimedia Subsystem (IMS) PDN or an INTERNET PDN.

11. The system of claim 9, wherein the second PDN is one of an IP Multimedia Subsystem (IMS) PDN or an INTERNET PDN.

12. The system of claim 9, wherein the UE switches to a legacy network for establishing a call, if both the first PDN connectivity request and the second PDN connectivity request are rejected.

13. A system comprising:
a User Equipment (UE) for wireless communication with a Mobile Management Entity (MME) adapted for improving registration for Voice over Long Term Evolution (VoLTE) enabled services in LTE networks, wherein the UE is configured for:
creating a first Packet Data Network (PDN) connectivity request for establishing connectivity with a first Packet Data Network (PDN) for establishing a call;
encapsulating an Evolved Packet Service (EPS) Session Management (ESM) message container in the first PDN connectivity request for sending a second PDN connectivity request in parallel with the first PDN connectivity request;
transmitting the first PDN connectivity request to a Mobile Management Entity (MME); and
establishing a PDN connectivity with at least one of the first PDN and the second PDN in response to parallel triggering of the first connectivity request to the first PDN and the second connectivity request to the second PDN by the MME.

14. The system of claim 13, wherein the UE establishes PDN connectivity with at least one of the first PDN and the second PDN based on network conditions.

15. The system of claim 13, wherein the ESM message container includes an Information Element (IE) providing a number of Access Point Names (APNs).

16. The system of claim 13, wherein the MME triggers the PDN connectivity requests to the first PDN and the second PDN in parallel.

17. The system of claim 13, wherein the UE is further configured to switch to a legacy network for establishing a call, if both the first PDN connectivity request and the second PDN connectivity request are rejected.
